(19) United States
(12) Patent Application Publication
(10) Pub. No.: US 2010/0301528 A1
(43) Pub. Date: Dec. 2, 2010

(54) CERAMIC FILTER COMPRISING A CARBON COATING AND A METHOD FOR MANUFACTURING THE SAME

(75) Inventors: Jianxun Zhu, Shandong (CN); Jinghao Liu, Shandong (CN); Shuli Shen, Shandong (CN)

Correspondence Address: OCCHIUTI ROHLICEK & TSAO, LLP, 10 FAWCETT STREET, CAMBRIDGE, MA, 02138, US

(73) Assignee: Jinan Shengquan Group Share-Holding Co., Ltd., Zhangqiu ,Jinan (CN)

(21) Appl. No.: 12/682,117

(22) PCT Filed: Jan. 28, 2008
(86) PCT No.: PCT/CN2008/000195

§ 371 Date: Apr. 8, 2010

(30) Foreign Application Priority Data
Oct. 8, 2007 (CN) 200710162723.1

(51) Int. Cl. C21C 7/00; B29C 59/00; B05D 5/00

(52) U.S. Cl. 266/229; 264/129; 427/244

(57) ABSTRACT

The present invention relates to a ceramic filter suitable for filtering molten metal, wherein said filter comprises a carbon coating and refractory materials bonded by ceramic binders, and said carbon coating is coated on the refractory materials which are bonded by ceramic binders. Furthermore, the present invention relates to the method for manufacturing said filter. The filter of the present invention has very high mechanical strength and stable quality, the preparation of which is more economic.

### TECHNICAL FILED

The present invention relates to a filter suitable for filtering molten meal, especially a ceramic filter comprising carbon coating. The present invention also relates to the method for manufacturing the said filter.

### BACKGROUND ART

In foundry production, the cast rejection rate due to foundry defects such as nonmetal intermingle impurity generally accounts for 50%-60% of the total amount of the wastes. The intermingle impurity not only decreases largely the mechanical property of the cast, but also has harmful effect on the working property and the appearance thereof. Purifying the liquid foundry alloy to reduce or eliminate various nonmetal intermingle impurity is definitely very important technical means to achieve high quality cast. The object for purifying the liquid foundry alloy can be realized effectively by employing filtration technique.

Filter technique has been applied on foundry production for about several decades. At the beginning, only simple filters such as wire netting, porous steel plate and porous mud core are inserted into the cast system to filter off the large block of intermingle impurity. Although the porous ceramic filter of sintering type developed firstly by U.S.A. at the beginning of 1970s solved the problems of easily leaking particles and inconvenient use, the porosity thereof is small, generally smaller than 50%, and the flow-through rate of the metal liquid is low, which is the same as the compressed beehive ceramic filter developed firstly by the U.S.A. at the beginnings of 1980.

The filtration technique of foam ceramics has developed quickly since foam ceramic filter for aluminum alloy was successfully developed firstly in 1978.

The ceramic filter existed in the market mainly includes alumina filter for filtering aluminum metal, silicon carbide filter for filtering foundry iron and zirconia filter for filtering molten steel. Among them, alumina filter and silicon carbide filter cannot be used for filtering the molten steel due to insufficient high temperature resistance and thermal shock resisting performance. The zirconia filter for filtering the molten steel has high production cost.

In order to improve the refractory properties and reduce the production cost of the filter, prior art disclosed the filter comprises carbon-based material which has higher refractory property. The refractory material comprising carbon-based material can endure a temperature higher than that of molten metal and prevent the metal from leaking; therefore such material has high strength and better thermal shock resisting performance under high temperature.

U.S. Pat. No. 5,104,540 (CORNING Inc.) disclosed a carbon-coated porous sintered ceramic filter for filtering the molten metal, wherein said filter comprises the monolithic substrtae formed from refractory material, such as alumina, mullite, zircon powder, zirconia, spinal, cordierite, lithium, alumino-silicate, titanate, feldspars, quartz, fused silica, silicon carbide, kaoline, aluminum titanate, silicates, aluminates and the mixture thereof. The carbon-based coating is applied on the surface of the mesh filter or used as a thermite. Said carbon coating did not subject to the sintering process. Said coating is prepared from the graphite powder, and thermite material can be mixed thereto.

U.S. Pat. No. 5,520,823 disclosed filters for filtering molten light metal (aluminum), wherein the employed binder is borosilicate glass. Although the filter contains graphite, considerable amount of graphite is lost due to sintering in air. The loss of graphite (carbon-based material) would limit the use of this filter to aluminum metal filtration only. Subsequently this filter is not suitable for molten iron or steel filtration.

WO 0218075A1 disclosed a filter for filtering the molten metal, wherein said filter comprises open-pored porous material containing refractory particles which are bonded together by a binder containing carbon, that is to say, there is no other bonding mechanism except for carbon binder. However, carbon binder is soft under room temperature, the refractory degree of the filter produced from carbon binder is worse than that of the filter produced from ceramics binder. Furthermore, it is difficult to control the carbon dioxide content in carbon filter during sintering and the quality of such filter is unstable.

### DISCLOSURES

In order to resolve the problems of above prior art, the present inventors developed a new filter through research work. The filter of present invention has high refractory property, high mechanic strength and stable quality, which is easily processed and stored.

In one aspect, the present invention relates to a ceramic filter suitable for filtering molten metal, wherein said filter comprises carbon coating and refractory material bonded by ceramic binder. Preferably, said carbon coating is coated on the refractory material bonded by ceramic binder. Most preferably, said carbon coating is coated on the said refractory materials through a sintering process. More specifically, based on the weight of the filter, the content of the refractory material is about 60-90wt. %, the content of the carbon coating is about 0.5-20wt. %, and the content of the ceramic binder is about 10-40wt. %. More preferably, the content of the refractory material is about 70-85wt. %, the content of the carbon coating is about 1-10wt. %, and the content of the ceramic binder is about 15-30wt. %. In a preferable embodiment, in the ceramic filter of present invention, said refractory material is one or more selected from the group consisting of zirconia, zircon powder, silicon oxide, alumina, titanium oxide, carbides, nitrates, magnesium oxide, nickel oxide, chromium oxide, mullite, talc, feldspar, pensil stone, wollastonite, and refractory clay, or any combinations thereof. Preferably, said carbides are silicon carbide, zirconium carbide titanium carbide, calcium carbide or aluminum carbide, and said nitrates are aluminum nitrate or silicon nitrate. In another preferable embodiment, in the ceramic filter of present invention, said carbon coating is prepared from the solution of one or more soluble carbon material selected from the group consisting of bitumen, tar, synthetic bitumen, synthetic and natural resin, sucrose and lignin, or any combinations thereof.

In another aspect of present invention, in the ceramic filter of present invention, said ceramic binder is any one or more selected from the group consisting of silicon binder, phosphate binder, glass binder and clay binder, or any combinations thereof. Preferably, said silicon binder is any one or more selected from the group consisting of silica gel, silica sol, active silica powder and silane and organic silicon compound, or any combinations thereof.

In a most preferable embodiment, in the ceramic filter of the present invention, said refractory material is alumina, carbon coating is obtained from the solution containing lignin, and said ceramics binder is active silica powder.

Preferably, said filter is a reticulated foam filter or a compressed filter.

In a further aspect of present invention, the present invention relates to a method for manufacturing the ceramic filter suitable for filtering molten metal, wherein said filter comprises a carbon coating and refractory materials bonded by ceramic binders, and said carbon coating is coated on the refractory materials bonded by ceramic binders. In particular, said method comprises the following steps: forming the mixture of refractory materials and ceramic binders into a desired shape, and applying carbon coating onto the same. Preferably, said method comprises the following steps: compressing the mixture of refractory material and ceramic binder into a disc or a slab in a die, then the compressed disc or slab are pierced through with a plurality of needles or rods to produce small pores in the cross section of the disc or slab and thus a compressed filter is obtained, then a carbon coating is coated on the said compressed filter. More preferably, in the above method, the content of the refractory material is about 60-90wt. %, the content of the carbon coating is about 0.5-20wt. %, and the content of the ceramic binder is about 10-40wt. %.

In a further aspect of present invention, the present invention relates to a method for manufacturing the ceramic filter suitable for filtering molten metal, wherein said filter comprises a carbon coating and refractory materials bonded by ceramic binders, and said carbon coating is coated on the refractory material bonded by a ceramic binder, characterized in that said method includes the following steps:
(1) preparing a slurry comprising refractory materials, a ceramic binder and a liquid carrier;
(2) coating the slurry prepared in step (1) onto a porous foam made from thermoplastic materials;
(3) drying the coated foam obtained in step (2);
(4) preparing a carbon coating;
(5) applying the carbon coating prepared in step (4) onto the ceramic foam obtained in step (3) or immersing the foam obtained in step (3) with the soluble carbon solution prepared in step (4) and drying the obtained article;
(6) optionally, repeating step (5) once or more times;
(7) performing sintering at temperature of 600-1100° C. under oxygen-free atmosphere and/or reducing atmosphere.

Preferably, in the above mentioned method, said refractory material is one or more selected from the group consisting of zirconia, zircon powder, silicon oxide, alumina, titanium oxide, carbides, nitrates, magnesium oxide, nickel oxide, chromium oxide, mullite, talc, feldspar, pensil stone, wollastonite, and refractory clay, and any combinations thereof. More preferably, said carbon coating is prepared from the solution of one or more soluble carbon material selected from the group consisting of bitumen, tar, synthetic bitumen, synthetic and natural resin, sucrose and lignin, and any combinations thereof. Most preferably, in the above mentioned method, said ceramic binder is any one or more selected from the group consisting of silicon binder, phosphate binder, glass binder and clay binder, and any combinations thereof, wherein said silicon binder is any one or more selected from the group consisting of silica gel, silica sol, active silica powder, silane and organic silicon compound, and any combinations thereof. Preferably, in the above mentioned method, said thermoplastic materials are polyurethanes.

Compared with the ceramic filter of prior art, especially the carbon-bonded filter comprising carbon-based material as a binder, the filter of present invention has the following advantages: firstly, the filter of present invention has higher strength; secondly, the filter mesh has stable quality in terms of strength and the rejection rate is low, because the sensitivity of the filter of present invention to oxygen-free atmosphere decrease largely when sintering and filter production is easy; thirdly, the filter of present invention has stable property during storing since the ceramics of present invention is more inert than carbon-bonded filter, while the carbon-bonded filter can easily absorb water during storing and the property of the filter is deteriorated; fourthly, the filter of present invention has stable quality, while it is difficult to control the content of carbon dioxide in carbon-bonded filter and the quality of which is unstable accordingly.

### DETAILED DESCRIPTION OF THE INVENTION

The present invention provides a ceramic filter suitable for filtering molten metal, wherein said filter comprise refractory materials bonded by a ceramic binder and carbon coating, and said carbon coating is coated on the refractory material bonded by a ceramic binder. In particular, said carbon coating is sintered on the refractory materials. The terms “bonded by a ceramic binder” means the refractory material is bonded together by a ceramic binder. Accordingly, the obtained filter is called a ceramic bonded filter or simply called a ceramic filter.

The refractory material used in the filter of the present invention can be any one that has erosive resistance and can withstand the high temperature of molten metal, as required by mesh filter. More specifically, the refractory material that is suitable for the invention comprises: zirconia, zircon powder, silicon oxide, alumina, titanium oxide, carbides (such as silicon carbide, zirconium carbide, titanium carbide, calcium carbide or aluminum carbide), nitrates (such as aluminum nitrate and silicon nitrate), magnesium oxide, nickel oxide, chromium oxide, mullite, talc, feldspar, pensil stone, wollastonite, and refractory clay, and any combinations thereof.

The form of the refractory materials may be particles, such as powder, fine powder, granule, fiber or bead. The size of the particles may be smaller than 50 μm, preferably smaller than 30 μm, more preferably smaller than 20 μm.

The said ceramic binder used in the present invention comprises various ceramic binders well-known in the field. For example, said ceramic binder is any one or more selected from the group consisting of silicon binder, phosphate binder, glass binder and clay binder, and any combinations thereof More specifically, said silicon binder can be any one that comprise silicon element and can bond together with the refractory materials. For example, said silicon binder is any one or more selected from the group consisting of silica gel, silica sol, active silica powder and silane and organic silicon compound, and any combinations thereof.

The relative percentages (wt. %) of refractory materials and ceramic binders are as follows: at least 60% refractory materials, no more than 40% ceramic binders; preferably, at least 70% refractory materials, no more than 30% ceramic binders; more preferably, at least 80% refractory materials, no more than 20% ceramics binders. For example, the amount of refractory material is in 70-85%, and the amount of ceramics binders is 15-30%.

Said carbon coating is prepared from the solution of one or more soluble carbon material selected from the group consisting of bitumen, tar, synthetic bitumen, synthetic and natural resin, sucrose and lignin, and any combinations thereof. Any other carbon material that can dissolve in the medium include but not limit to water, can be used for the present invention. In the filter of present invention, based on the total weight of the filter, the content of the carbon coating is about 0.5-20%, preferably about 1-10%, more preferably about 1-5%. The examples of the above said synthetic resin can be phenolic resin or furan resin. Said solution of soluble carbon material or soluble carbon solution can be obtained by dissolving the carbon material in water or other organic solvents. The concentration of said solution varies depending on the different carbon material, for example, 10-50% weight/volume, preferably, 20-30% weight/volume. For example, the present invention preferably uses aqueous solution of lignin or sucrose both having a concentration of 25% weight/volume.

The filter of present invention is suitable for filtering various molten metals, such as iron, steel or alloy.

The filter of present invention can be prepared into a form of open-pored porous material. The open-pored porous material means that the solid material includes pores having regular, partly regular, non regular and random distribution, these pores being the passage of the molten metal. Such pores can communicate with each other totally or partly, or have several passages for passing through of the molten metal. The size and shape of the pores itself can be regular or irregular. For example, such pores can comprise a series of parallel passages passing through linearly the solid material, and the passage has any required cross section, such as communicated passage of circle, ellipse or triangle, which has similar porous distribution as that of natural foam. The preferable open-pored porous materials are reticulated open-pored polyurethane foam which is market available and has relatively regular distribution. It is well-known that such material can be used in the manufacture of the refractory material filter for filtering molten metal.

The present invention further comprises a method for manufacturing the ceramic filter suitable for filtering molten metal, wherein said filter comprises carbon coating and refractory materials bonded by ceramic binders, and said carbon coating is coated on the refractory material bonded by a ceramic binder. More specifically, said method comprises the following steps: the mixture of refractory materials and ceramic binders are molded into required shape such as open-pored porous shape, and then the said carbon coating is coated thereon.

More specifically, the open-pored porous material can be manufactured by the following method: the mixture of refractory materials and silicon binders are compressed into a disc or a slab in a die, then the compressed disc or slab are pierced through with a plurality of needles or rods to produce small pores in the cross section of the disc or slab, the shape of the pore may be pentagon. It is desirable that these pores are arranged in a regular grid pattern on the surface of the compressed disc or slab. Another similar product can be prepared by extruding a mixture of refractory materials and silicon binders. It is desirable that a liquid and/or other additive are added into the mixture to facilitate the extrusion. After completing the extrusion, small pores are produced in the extruded article using a die equipped with a plurality of mandrels. Such extruding process is commonly used in the field.

The said carbon coating can be coated on the open-pored porous material comprising ceramic binders and refractory materials using any method well-known in the art. For example, soluble carbon solution can be coated onto the above open-pored material through spaying or immersing. The said carbon coating can be obtained through the way of spaying if the thickness of the open-pored porous material is not deep. Immersing method will be used to coat the carbon material onto the surface and the pore inside of the open-pored porous material if the thickness of the open-pored porous material is deep. If necessary, the above spaying and/or immersing can be repeated once or more times to reach the desired content of the carbon coating.

The above open-pored porous material coated with soluble carbon solution need to be dried, for example, dried at 110° C. under air atmosphere.

The last step is sintering which need to be carried out under oxygen-free or reductive atmosphere. The temperature is about 600-1100° C., preferably about 900° C.

According to the present invention, a method for manufacturing the open-pores porous material (filter) suitable for filtering molten metal comprises the following steps:
(1) preparing a slurry comprising refractory materials, ceramic binders and a liquid carrier;
(2) coating the slurry prepared in step (1) onto a porous foam made from thermoplastics;
(3) drying the coated foam obtained in step (2);
(4) preparing a carbon material coating;
(5) applying the carbon coating prepared in step (4) onto the foam obtained from step (3) or immersing the foam obtained in step (3) in the carbon coating prepared in step (4) and drying the obtained article;

The refractory materials and ceramic binders used in step (1) are substantially same as that described above. Generally, a liquid carrier is water without exclusion of other liquids such as methanol, ethanol and isopropanol.

If necessary, step (5) can be repeated once or more times so as to reach the desired thickness of the carbon coating.

It is also possible to add dispersing agent into the above slurry to dispersing the powder into the water during the siring process, and the added amount is several percentage (such as 1-10%, preferably 1-6%). It is ordinary to use dispersing agent during ceramics powder mixing. Common dispersing agents are those well known in the art, such as sodium hexametaphosphate, sodium tripolyphosphate, polyacrylamide or sulfonic substances.

The soluble carbon solution is obtained by dissolving the soluble carbon material in solvent such as water. If necessary, organic solvent such as methanol can be used. The concentration of the soluble carbon solution can be such as 10-50% weight/volume, preferably 20-40% weight/volume, more preferably 25% weight/volume. The preferred soluble carbon solution is such as lignin aqueous solution of 25%.

For example, the reticulated foam made of thermoplastic materials can be reticulated polyurethane foam.

The commonly used coating is suitable for reticulated foam. For example, polyurethane foam can be immersed into the slurry or the slurry can be spayed onto the polyurethane foam, the obtained article then subject to a pair of roller so as to adjust the distribution and the amount of the slurry on the foam. Therefore, a preferred method for manufacturing a filter is as follows: for example, the polymer (generally polyurethane) foam was immersed into the slurry (generally water based slurry) by a person skilled in the art according to traditional method, and said slurry was the mixture of particle refractory materials and binders, then drying, to produce a foam structure coated with the silicon binder bonded refractory material, ready for the subsequent step of coating the carbon coating.

The reticulated foam after coating need to be dried at a temperature of about 110° C. If necessary, the above steps of coating and drying can be repeated once or more times so as to reach the desired thickness.

The next step of the process is to prepare the carbon coating and coat it onto the dried reticulated foam coated with ceramic bonded refractory materials. The carbon coating can be obtained by dissolving soluble carbon material in water or other solvents. In order to coat the carbon coating onto said foam, methods such as spraying or immersing can be used for the present invention. Similarly, after coating the carbon coating, said foam need to be dried, for example, at high temperature under air atmosphere. If necessary, the above coating and drying steps for carbon coating can be repeated once or more times until reaching the desired thickness of the carbon coating.

The last step of the process is to sinter the above dried foam. The sintering temperature should be high enough to bond the refractory material and the carbon coating together by the ceramics binder. For example, the sintering temperature is about 600-1100° C., preferably about 900° C. It is desirable than the sintering is performed under oxygen-deficient atmosphere, for example, an inert “oxygen-free” atmosphere, such as nitrogen or argon, or vacuum, or under “reductive atmosphere”, such as hydrogen and/or carbon oxide and/or coal gas (i.e. the mixture of methane and hydrogen).

Generally, sintering is performed in a drying furnace or a kiln; other heat resource can also be used, such as microwave for wireless frequency heating.

The advantages of the process for manufacturing the filter according to present invention are as follows: excellent mechanical property, heat shock resistance, stable quality, and such a filter does not easily break during conveying and transporting process, and it has stable property during storing. The production and the property of the filter manufactured according to the present invention are more stable. Compared with the filter containing carbon binder, the difference between various filters of present invention decreases largely. The sintering of filter comprises carbon binder required to be conducted under special sintering atmosphere and it is necessary to control the oxygen content during filter sintering. The ceramic filter comprises ceramics binder according to present invention is less sensitive to the oxygen content during sintering.

### EXAMPLES

### Example 1

Alumina powder: 75%

Active silica powder: 25%

All the above materials were market available, and said percentages were wt. %. Into the mixture of alumina powder and active silica powder, 2% of sodium hexametaphosphate and 20% of water were added thereto. The powdery materials and water were mixed using high performance mixer to prepare the slurry. Such slurry was used for coating polyurethane foam. The polyurethane foam coated with slurry was dried at 110° C. The used polyurethane foam was market available.

Aqueous solution of calcium lingosulphonate of 25 wt. % was prepared. The prepared aqueous solution was spayed onto the above obtained filter and the coated filter was dried at 110° C. Finally, the filter of present invention was obtained by sintering at 900° C. under oxygen-free atmosphere. After measurement, carbon coating accounted for about 4 wt. % of the filter.

The size of the filter prepared according to the above formulation was 50*50*15 mm. Such filter was used to filter 50 kg of molten steel at 1650° C. As a result, the filter withstood the testing condition and it performed as required in filtering the molten steel.

### Example 2

Alumina powder: 90%

Aluminum phosphate: 10%

All the above materials were market available, and said percentages were wt. %. Into the mixture of alumina powder and aluminum phosphate powder, 2% of sodium hexametaphosphate and 20% of water were added thereto. The powdery materials and water were mixed using high performance mixer to prepare the slurry. Such slurry was used for coating polyurethane foam. The polyurethane foam coated with slurry was dried at 110° C. The used polyurethane foam was market available.

Aqueous solution of sucrose of 25 wt. % was prepared. The prepared aqueous solution was spayed onto the above obtained filter and the coated filter was dried at 110° C. Finally, the filter of present invention was obtained by sintering at 900° C. under oxygen-free atmosphere. After measurement, carbon coating accounted for about 4 wt. % of the filter.

The size of the filter prepared according to the above formulation was 50*50*15 mm. Such filter was used to filter 50 kg of molten steel at 1650° C. As a result, the filter withstood the testing condition and it performed as required in filtering the molten steel.

### Example 3

Alumina powder: 85%

Glass powder: 15%

All the above materials were market available, and said percentages were wt. %. Into the mixture of alumina powder and glass powder, 2% of sodium hexametaphosphate and 20% of water were added thereto. The powdery materials and water were mixed using high performance mixer to prepare the slurry. Such slurry was used for coating polyurethane foam. The polyurethane foam coated with slurry was dried at 110° C. The used polyurethane foam was market available.

Aqueous solution of calcium lingosulphonate of 25 wt. % was prepared. The prepared aqueous solution was spayed onto the above obtained filter and the coated filter was dried at 110° C. Finally, the filer of present invention was obtained by sintering at 900° C. under oxygen-free atmosphere. After measurement, carbon coating accounted for about 4 wt. % of the filter.

The size of the filter prepared according to the above formulation was 50*50*15 mm. Such filter was used to filter 50 kg of molten steel at 1650° C. As a result, the filter withstood the testing condition and it performed as required in filtering the molten steel.

### Example 4

Alumina powder: 80%

Refractory clay: 20%

All the above materials were market available, and said percentages were wt. %. Into the mixture of alumina powder and refractory clay powder, 2% of sodium hexametaphosphate and 20% of water were added thereto. The powdery materials and water were mixed using high performance mixer to prepare the slurry. Such slurry was used for coating polyurethane foam. The polyurethane foam coated with slurry was dried at 110° C. The used polyurethane foam was market available.

Acetone solution of phenolic resin of 25 wt. % was prepared. The prepared aqueous solution was spayed onto the above obtained filter and the coated filter was dried at 110° C. Finally, the filer of present invention was obtained by sintering at 900° C. under oxygen-free atmosphere. After measurement, carbon coating accounted for about 4 wt. % of the filter.

The size of the filter prepared according to the above formulation was 50*50*15 mm. Such filter was used to filter 50 kg of molten steel at 165° C. As a result, the filter withstood the testing condition and it performed as required in filtering the molten steel.

1. A ceramic filter suitable for filtering molten metal, wherein said filter comprises a carbon coating and refractory materials bonded by ceramic binders, and said carbon coating is coated on the refractory materials which are bonded by ceramic binders.

2. The ceramic filter as recited in claim 1, wherein said carbon coating is coated on the refractory materials bonded by ceramic binders through a sintering process.

3. The ceramic filter as recited in claim 1, wherein the content of the refractory material is about 60-90wt. %, the content of the carbon coating is about 0.5-20wt. %, and the content of the ceramic binder is about 10-40wt. %.

4. The ceramic filter as recited in claim 1, wherein the content of the refractory material is about 70-85wt. %, the content of the carbon coating is about 1-10wt. %, and the content of the ceramic binder is about 15-30wt. %.

5. The ceramic filter as recited in claim 1, wherein said refractory material is one or more selected from the group consisting of zirconia, zircon powder, silicon oxide, alumina, titanium oxide, carbides, nitrates, magnesium oxide, nickel oxide, chromium oxide, mullite, talc, feldspar, pensil stone, wollastonite, and refractory clay, and any combinations thereof.

6. The ceramic filter as recited in claim 5, wherein said carbides are silicon carbide, zirconium carbide, titanium carbide, calcium carbide or aluminum carbide, and said nitrates are aluminum nitrate or silicon nitrate.

7. The ceramic filter as recited in claim 1, wherein said carbon coating is prepared from one or more carbon material selected from the group consisting of bitumen, tar, synthetic bitumen, synthetic and natural resin, sucrose and lignin, and any combinations thereof.

8. The ceramic filter as recited in claim 1, wherein said ceramic binder is any one or more selected from the group consisting of silicon binder, phosphate binder, glass binder and clay binder, and any combinations thereof.

9. The ceramic filter as recited in claim 8, wherein said silicon binder is any one or more selected from the group consisting of silica gel, silica sol, active silica powder, silane and organic silicon compound, and any combinations thereof.

10. The ceramic filter as recited in claim 1, wherein said refractory material is alumina, said carbon coating is obtained from lignin, and said silicon binder is active silica powder.

11. The refractory filter as recited in claim 1, wherein said filter is a reticulate foam filter or a pressed filter.

12. A method for manufacturing a ceramic filter suitable for filtering molten metal, wherein said filter comprises a carbon coating and a refractory material bonded by a ceramic binder, and said carbon coating is coated on the refractory material bonded by a ceramic binder, comprising forming the mixture of refractory material and ceramic binder into a desired shape, and coating a carbon coating on the same.

13. The method as recited in claim 12, wherein said method comprises the following steps: the mixture of refractory material and ceramics binder is compressed into a disc or a slab in a die, then the compressed disc or slab is pierced through with a plurality of needles or rods to produce small pores in the cross section of the disc or slab and thus the said compressed filter is obtained, then carbon coating is coated on the said compressed filter.

14. The method as recited in claim 12, wherein, based on the weight of the filter, the content of the refractory material is about 60-90 wt. %, the content of the carbon coating is about 0.5-20 wt. %, and the content of the ceramic binder is about 10-40 wt. %.

15. A method for manufacturing a ceramic filter suitable for filtering molten metal, wherein said filter comprises carbon coating and refractory material bonded by a ceramic binder, and said carbon coating is coated on the refractory material bonded by a ceramic binder, characterized in that said method includes the following steps:
(1) preparing a slurry comprising a refractory material, a ceramic binder and a liquid carrier;
(2) coating the slurry prepared in step (1) onto a porous foam made from thermoplastic materials;
(3) drying the coated foam obtained in step (2);
(4) preparing a carbon coating;
(5) applying the carbon coating prepared in step (4) onto the foam obtained in step (3), and drying the coated foam;
(6) optionally, repeating step (5) once or more times;
(7) performing sintering at a temperature of 600-1100° C. under oxygen-free atmosphere and/or reducing atmosphere.

16. The method as recited in claim 15, wherein said refractory material is one or more selected from the group consisting of zirconia, zircon powder, silicon oxide, alumina, titanium oxide, carbides, nitrates, magnesium oxide, nickel oxide, chromium oxide, mullite, talc, feldspar, pensil stone, wollastonite, and refractory clay, and any combinations thereof.

17. The method as recited in claim 15, wherein said carbon coating is prepared from the solution of one or more soluble carbon material selected from the group consisting of bitumen, tar, synthetic bitumen, synthetic and natural resin, sucrose and lignin, and any combinations thereof.

18. The method as recited in claim 15, wherein said ceramics binder is any one or more selected from the group consisting of silicon binder, phosphate binder, glass binder and clay binder, and any combinations thereof.

19. The method as recited in claim 15, wherein said silicon binder is any one or more selected from the group consisting of silica gel, silica sol, active silica powder and silane and organic silicon compound, and any combinations thereof.

20. A method as recited in claim 15, wherein said thermoplastic materials are polyurethanes.
